(19) United States
(12) Patent Application Publication
(10) Pub. No.: US 2005/0042071 A1
(43) Pub. Date: Feb. 24, 2005

(54) Truncated pyramidal golf ball positioning device with insert

(76) Inventor: Gregory J. Kelly, Duluth, GA (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/645,228

(22) Filed: Aug. 21, 2003

(51) Int. Cl. B25J 1/00

(52) U.S. Cl. 414/754

(57) ABSTRACT

A truncated pyramidal stack of golf balls arranged to have a layer of golf balls that includes a void that may be filled by a spacer insert. The truncated pyramidal stack is arranged upright to rest upon a tray that has an upstanding periphery. A hopper with an open base is used to guide the golf balls to form the truncated pyramidal shape. The spacer insert may be hollow to accommodate golfing tees or other items pertaining to golf.

### CROSS-REFERENCE TO RELATED PATENT APPLICATIONS

Ser. No. 10/461,624 filed Jun. 13, 2003

### BACKGROUND OF THE INVENTION

1. Field of the Invention

The present invention relates to an insert for a truncated pyramidal golf ball positioning device that takes the place otherwise filled by golf balls.

2. Discussion of Related Art

Positioning devices capable of stacking golf balls to form a pyramidal stack of golf balls are known from U.S. Pat. No. 5,551,832 and U.S. Pat. No. 5,595,312. The basic idea is to fill the interior with an inverted hopper having an pyramidal shape that is open at the inverted base, placing a tray to close the inverted base, flipping the closed pyramid shape, removing the hopper. What remains standing is a stack of golf balls that form a pyramidal shape on the tray.

While such positioning devices are suited for use at golf ball driving ranges, there are other uses for them. They may be used to contain golf balls in a pyramidal stack to be given as a gift to a golfer. If the hopper is transparent, one might display prized golf balls inside and place the positioning device in an area for display. Such uses have one thing in common: the interior of the positioning device need not necessarily be filled with golf balls. Indeed, considering the cost structure for golf balls, it would be advantageous to provide flexibility in the number of golf balls that need to be included to fill the positioning device sufficiently to maintain the appearance oft the golf balls being stacked in a pyramid when they are resting on the tray.

### SUMMARY OF THE INVENTION

One aspect of the invention relates to a spacer insert arranged to fill a void within a truncated pyramid stack of golf balls that may otherwise be filled by at least one golf ball. The spacer insert may be sized to take the place of one or more golf balls in the stack. The spacer insert may be hollow so that an item may be contained within its confines, such as a golf related item.

Another aspect of the invention resides in a positioning device that has a hopper, golf balls within the hopper and a spacer insert within the hopper. The golf balls form multiple layers of a pyramid stack. The spacer insert is within one of the layers of golf balls, thereby taking the place of golf balls that would otherwise be included to fill out the pyramid shape. The hopper has the shape of an inverted, truncated pyramid. When a tray closes the open base of the inverted, truncated pyramid and the hopper is flipped over, the golf balls are stacked in a shape of a truncated, pyramid, whether the spacer insert is kept in or not. The spacer insert may be hollow and accommodate golf tees or other golf related items. The golf ball pyramid stack may be upright on a tray, with its base layer in contact with an inner facing surface of an upstanding periphery of the tray and remain upright, preferably, whether or not the spacer insert remains in position filling the void in the pyramid stack.

### BRIEF DESCRIPTION OF THE DRAWING

For a better understanding of the present invention, reference is made to the following description and accompanying drawings, while the scope of the invention is set forth in the appended claims:

FIG. 1 is an isometric view of a positioning device in accordance with an embodiment of the invention.

FIG. 2 is a bottom view of FIG. 1.

FIG. 3 is an elevational view of two positioning devices of FIG. 1 stacked one atop the other.

FIG. 4 is an isometric view of a spacer.

### DETAILED DESCRIPTION OF THE INVENTION

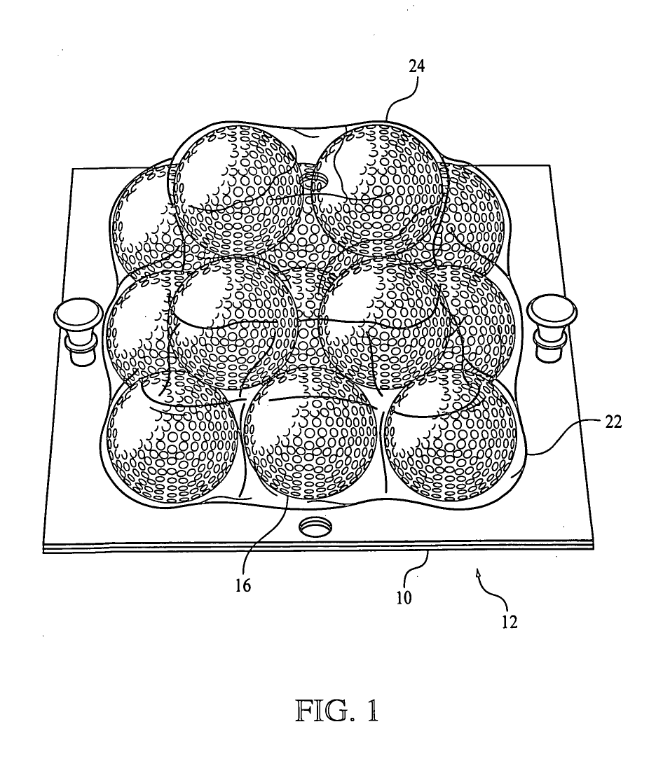

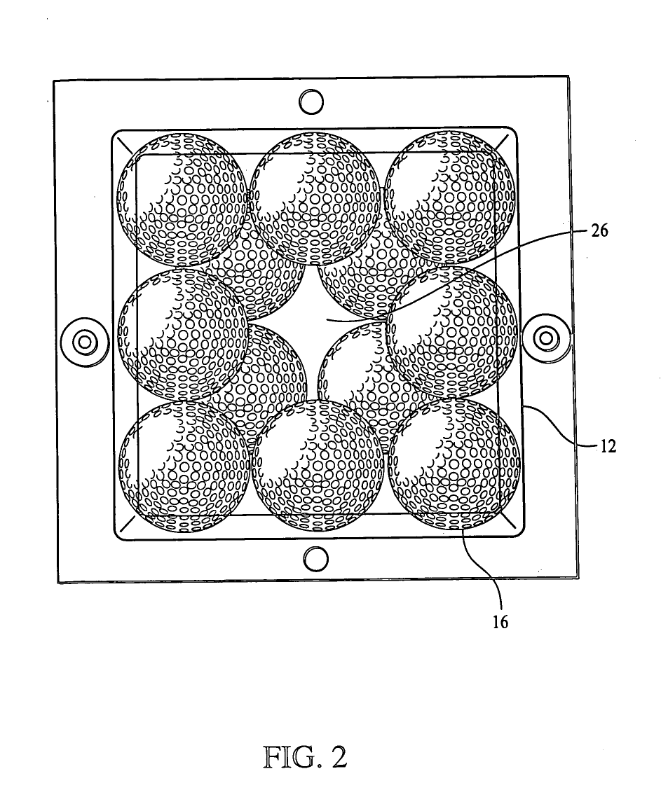

FIGS. 1-3 show a positioning device that includes a hopper 10 and a tray 12 that may be constructed in accordance with their counterparts found in U.S. Pat. No. 5,551,832 and U.S. Pat. No. 5,595,312, whose contents are incorporated herein by reference. The hopper 10 and tray 12 form a truncated pyramidal shape. Golf balls filling the interior art stacked to form a truncated pyramid. One or more golf balls, otherwise filling the interior, may be replaced by a spacer insert 14.

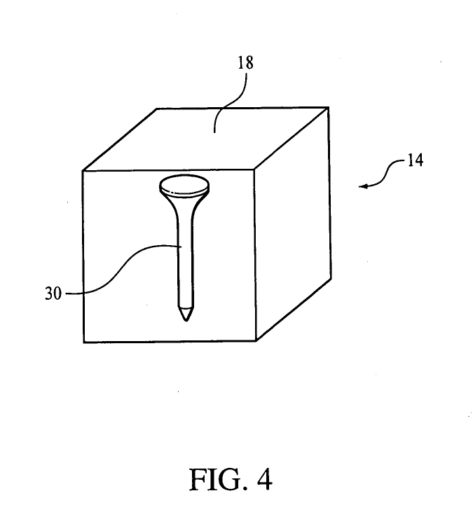

As shown in FIG. 4, the spacer insert 14 may be of solid or hollow construction and may have all flat surfaces. It may be constructed in accordance with either the spacer insert 14 or spacer insert 20 of U.S. Ser. No. 10/461,624, whose contents are incorporated by reference. If hollow, the spacer insert may have a lid hinged inside (hinge not shown) or slideably secured to an adjacent wall of the spacer insert. This permits one or more items 30 to be placed into the spacer insert 14, or removed from it. The items may be golfer's tees or other items pertaining to golf, although such items may as an alternative have nothing to do with golf.

The hopper may be made from transparent or translucent material, because the inside may be viewed from outside. Thus, prized golf balls, for instance, may be displayed prominently within the hopper. The inside of the truncated pyramidal stack, which is not visible from the outside when the hopper is upright, may have the spacer insert. However, the spacer insert 14 may be removed and still the golf balls will remain in their stacked, truncated pyramidal shape.

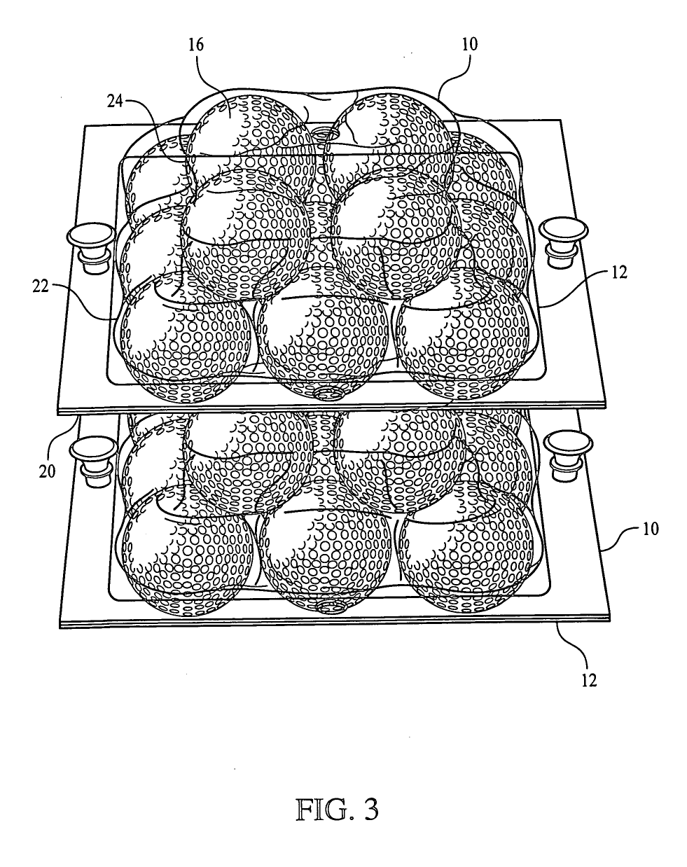

The golf ball positioning device may include the tray 12 having an upstanding periphery 20 as shown in FIG. 3. The truncated pyramidal stack of golf balls 16 are stacked upright on the tray 12. The truncated pyramidal stack of golf balls 16 include a plurality of layers of golf balls. These layers include a base layer 22 and a top layer 24 atop the base layer 22. The base layer 22 fits within the confines of the upright periphery 20 and contacts an inner facing surface of the upstanding periphery. The base layer 22 may have a void 26 between the tray and at least some of the golf balls of the top layer 24 that is free of any golf balls, the void being of a dimension such that a volume of one of the golf balls may be accommodated in the void. That void may be where the spacer insert 14 was located before its removal from the confines of the hopper 10. Alternatively, the spacer insert 14 may be left within the hopper to rest on the tray 12 and fill in this void on the tray.

The spacer insert 14 is sized to fill the space otherwise occupied by a single golf ball, or may be sized to fill one space otherwise occupied by multiple golf balls. The spacer insert 14 may be positioned anywhere and either spaced apart from other spacer inserts or arranged adjacent one or more spacer inserts.

The stack of golf balls are stable for standing upright if arranged in a truncated pyramid, such as in two layers—the top layer having four balls and the bottom layer having eight balls with a spacer. A regular pyramid would have three layers—the top layer being a single golf ball. However, the truncated pyramid of this invention envisions the omission of such a single golf ball so that the layer with four golf balls becomes the top layer, which gives rise to the truncation of the pyramid. The hopper 10, therefore, is truncated or, if formed as a regular pyramid, its cone apex is blocked off internally to prevent a single golf ball from entering the void otherwise defined by the interior of the cone apex.

Since the top and bottom exterior surfaces of the positioning device are substantially flat, they may be stacked one onto the other, which facilitates that storage in a more compact manner than would otherwise be the case.

While the foregoing description and drawings represent the preferred embodiments of the present invention, it will be understood that various changes and modifications may be made without departing from the spirit and scope of the present invention.

1. A golf ball positioning device, comprising:
a hopper having an open base,
a spacer insert that is located within confines of the hopper; and
golf balls within the hopper, the golf balls and the spacer insert being arranged so that the golf balls stack on each other to form a truncated pyramidal shape with the spacer insert filling a void that otherwise may be filled by at least one of the golf balls.

2. A device as in claim 1, further comprising a tray accommodating the open base to close same so that upon flipping the hopper over to an upright position from an inverted position, the golf balls remain in the truncated pyramidal shape although resting on the tray.

3. A device as in claim 2, wherein the hopper and spacer insert are configured so that the golf balls remain in the truncated pyramidal shape upon the flipping even though the spacer insert is removed after the golf balls have formed their truncated pyramidal shape within the hopper and before the flipping.

4. A device as in claim 1, wherein the spacer insert is solid.

5. A device as in claim 1, wherein the spacer insert is hollow.

6. A device as in claim 5, wherein the spacer insert includes a lid hinged to a remainder of the spacer insert.

7. A device as in claim 5, wherein tees are within the hollow of the spacer insert.

8. A device as in claim 5, wherein an item pertaining to golf is within the spacer insert.

9. A method of positioning golf balls, comprising:
pouring golf balls within a hopper having an open base,
placing a spacer insert within confines of the hopper; and
arranging the golf balls and the spacer insert so that the golf balls stack on each other to form a truncated pyramidal shape having a void filled by the spacer insert that otherwise may be filled by at least one of the golf balls.

10. A method as in claim 9, further comprising accommodating the open base to close same with a tray so that upon flipping the hopper over to an upright position from an inverted position, the golf balls remain in the truncated pyramidal shape although resting on the tray.

11. A method as in claim 10, further comprising configuring the hopper and spacer insert so that the golf balls remain in the truncated pyramidal shape upon the flipping even though the spacer insert is removed after the golf balls have formed their truncated pyramidal shape within the hopper and before the flipping.

12. A method as in claim 10, further comprising opening a lid on the spacer insert to gain access to contents of the spacer insert.

13. A golf ball positioning device, comprising:
a tray having an upstanding periphery; and
a truncated pyramidal stack of golf balls stacked upright on the tray, the truncated pyramidal stack including a plurality of layers of golf balls including a base layer of golf balls and a top layer of golf balls, the base layer of golf balls fitting within the confines of the upright periphery and contacting an inner facing surface of the upstanding periphery, at least one of the layers of golf balls having a void that is free of any golf ball, the void being of a dimension such that a volume of at least one of the golf balls may be accommodated in the void.

14. A device as in claim 13, further comprising a spacer insert filling the void.

15. A device as in claim 14, wherein the layers are arranged to define a further void between the tray and at least some of the golf balls of the top layer, a further spacer insert filling the further void.

16. A device as in claim 15, wherein the spacer and the further spacer are adjacent each other.

17. A device as in claim 15, wherein the spacer and the further spacer are spaced apart.

18. A device as in claim 13, further comprising a hopper secured to the tray, the hopper and tray defining a space therebetween that is accommodated by the truncated pyramidal stack of golf balls.

19. A golf ball positioning device, comprising two units stacked one atop the other, each unit including a hopper having a shape of a truncated pyramid and a tray with an upstanding periphery to which rest the hopper, each of the units containing a plurality of golf balls stacked in layers on top of each other resting on the tray to form a truncated pyramid.

20. A device as in claim 19, wherein at least one of the layers of golf balls includes a void between neighboring ones of the golf balls and having a dimension at least that of one of the golf balls.

21. A device as in claim 20, further comprising a spacer within the void.
